(19) United States
(12) Patent Application Publication
(10) Pub. No.: US 2019/0377857 A1
(43) Pub. Date: Dec. 12, 2019

(54) LOCKING ENCLOSURE FOR PERSONAL BELONGINGS

(71) Applicants: Nelly M. J. Bateman, Sandy, UT (US); Sephora L. Bateman, Sandy, UT (US); Senora L. Bateman, Sandy, UT (US); Orland C.L. Bateman, Pasadena, CA (US)

(72) Inventors: Nelly M. J. Bateman, Sandy, UT (US); Sephora L. Bateman, Sandy, UT (US); Senora L. Bateman, Sandy, UT (US); Orland C.L. Bateman, Pasadena, CA (US)

(21) Appl. No.: 16/434,862

(22) Filed: Jun. 7, 2019

Related U.S. Application Data
(60) Provisional application No. 62/682,911, filed on Jun. 9, 2018.

(51) Int. Cl. G06F 21/32; A44B 19/30; E05B 45/06

(52) U.S. Cl. CPC G06F 21/32; A45C 1/06; E05B 45/06; A44B 19/301

(57) ABSTRACT

A locking enclosure for personal belongings may include a container with a biometric activated lock for providing selected access to the container, with the locking mechanism being programmed to open in response to a predetermined voice. The container may be a wallet, a purse, a backpack, a piece of luggage or a tent, and a locking mechanism on the container may include a voice print a fingerprint or a retinal scan so that when the proper biometric data is acquired, the user may easily access the contents of the container.

### BACKGROUND

### State of the Art

The present invention relates to an improved enclosure for personal belongings, such as a wallet, purse, backpack, luggage or even a tent. More particularly, the present invention relates to an approved wallet, purse, backpack, piece of luggage, hand bag, tote, sleeping bag or tent, which can be selectively locked to prevent theft and the like while providing minimal inconvenience to the owner.

### Field of Art

The theft of personal information and assets has become a serious problem over the years. Many criminals actively look for situations in which they may acquire another person's information or assets such as money or credit cards to use to acquire goods or services. Because of the widespread theft and misuse of credit cards and debit cards and the like, many credit card companies and banks provide information by which a user can immediately lock or cancel the debit card or credit card. Because of this, most criminals realize that once they obtain a credit card or debit card they must use it as quickly as possible to avoid getting caught and to avoid the card from being deactivated prior to illegal use.

The theft of credit cards and the like is typically a crime of opportunity. A person may accidentally leave or drop their wallet in a store, or even leave it sitting on their office desk while attending a meeting. Traditionally, a criminal seeing a wallet having been left would promptly grab the wallet, remove any cash or credit cards in the wallet, and then throw the wallet away so that a person who had lost their wallet would not see it in the possession of the criminal. The criminal would then promptly attempt to use the cards to make purchases before the owner realized that the cards had been stolen.

Because of the speed at which cards may now be cancelled, more intelligent criminals have come to realize that it is often not in their best interest to steal a wallet. If a wallet is found, the criminal may simply remove one credit card from the wallet and return the wallet to the location where it was found. When the owner of the wallet returns after realizing that the wallet was misplaced, the owner is usually relieved that the wallet has been found and may simply look quickly to determine if the contents of the wallet, such as cash, are present. If so, the owner will often not conduct a thorough investigation and may not even remember all of the cards which the user had in the wallet. Thus, the clever thief may have obtained hours or even days in which to use a card before the owner realizes that a card has been stolen.

An even more clever criminal may not take any cards from the wallet. Rather, by using the camera on a mobile telephone, the criminal may take a photograph of a card, including the card number and the security code. The owner's driver's license may also be photographed to gain information. That information can then be used to purchase items on-line, over the phone, or in other environments where the physical card is not required. In such a manner, a clever criminal may be able to make purchases for days or even weeks without the owner realizing that the card has been compromised. If the credit card is a company credit card, it may be months before the company realizes that unauthorized charges are being made to the account.

While the loss of a wallet in a public place is most likely to cause a person to consider cancelling their cards, theft of cards and other information from a wallet can occur in a variety of other locations—such as a person's place of employment or even in an apartment with roommates. Because the owner has not “lost” their wallet, they may be completely unaware that a co-worker, cleaning crew or roommate has either taken a card or taken information to allow an unauthorized use of the card. A stealthy coworker may even be able to remove a card, make a large purchase, and then return the card to the wallet undetected. Disputing the charge weeks later may be difficult when the owner had used the card shortly before and shortly after the theft and the credit card company documents that the card was used in person to make the unauthorized purchase.

Backpacks present a similar problem. Many students, travelers and others use backpacks to carry books, electronics and other valuables. Backpacks are convenient because they may be carried without occupying the user's hands. Backpacks present a problem, however, because they are susceptible to pickpockets and the like. While a person is walking down a street wearing a backpack, a pickpocket may follow closely behind and carefully unzip one or more of the zippers on the backpack. The pickpocket can then remove items from the backpack without the owner being aware. If the pickpocket closes the zipper, the user of the backpack may not even realize that items have been stolen until much later when they go to retrieve something from the backpack.

The risk of having pickpockets remove material from a backpack is well appreciated and there are several antitheft backpacks currently available. These backpacks typically include zippers with an extra catch or fabric which conceals the zippers to make it harder for a thief to unzip a pocket. With sufficient time, however, the thief can still access pockets of a backpack even while it is being worn by its owner.

The use of luggage can create similar problems. Many airports now provide warnings to travelers to ensure that they have not left their baggage unattended. Criminals or terrorists could place contraband or explosives within luggage leading to the luggage owner being arrested upon going through security or injured if the explosive is detonated. Moreover, if the luggage explodes, the luggage owner, who is actually a victim, may appear to be a perpetrator.

Likewise, most travelers leave their luggage in a hotel room which can be accessed by employees of the hotel or criminals who have stolen keys or access credentials. The criminal may go through luggage and remove valuables. Alternatively, a criminal could plant contraband, such as drugs. The luggage's owner could then unknowingly transport the drugs across borders. If the owner is caught by customs he/she may be arrested. If the owner is lucky enough to make it through customs, he or she may find their luggage stolen shortly after arrival by the criminals who have used the luggage owner as a “mule” without the owner's knowledge.

Tents can present a similar situation. When a person is in the outdoors it is common to leave some valuables in a tent. There is a risk, however, that persons may enter the tent and remove valuables while the camper is hiking, fishing, or doing other activities. Sometimes the theft will be immediately obvious. However, a camper might not realize that valuables have been stolen for many hours or even days.

Attempts have been made to provide locks for items like suitcases. These are typically combination locks with three sets of numbers. While such locks will delay a criminal, the locks have only 1000 combinations and can be overcome with enough time. Additionally, such locks are inconvenient for the user, as the user must turn the dials to open the lock each time he or she needs access to the luggage. Thus, it is common for travelers to only lock the locks when they plan on being gone for a prolonged period of time.

Thus, there is needed improved wallets, purses, luggage tents and other containers for personal information or valuables to reduce the risk of unauthorized access to the contents thereof and provide an indication if such access has been obtained.

### SUMMARY OF THE INVENTION

The following summary of the present invention is not intended to describe each illustrated embodiment or every possible implementation of the invention, but rather to give illustrative examples of application of principles of the invention.

The present invention involves personal item containers having a zipper and a biometrically activated locking mechanism to selectively prevent opening of the zipper. The locking mechanism may include one of a variety of biometrically activated sensors disposed in communication with software programmed to store one or more biometric prints and to compare detected biometric information to the biometric print(s) so that only the owner or a limited number of authorized users may unlock the locking mechanism and allow the zipper to be opened. In such a manner, the user may have confidence that the contents of the carrying case have not been accessed.

In accordance with one aspect of the present disclosure, the biometric data sensed is a voice and the sensed data is compared to a voiceprint accessible by the software. When the sensed voice matches the voiceprint, the locking mechanism may be released to allow access to the wallet, purse, bag, tent, etc.

In accordance with one aspect of the present disclosure, the biometric data sensed may be a fingerprint and the sensed data is compared to stored fingerprint data accessible by the software. When the sensed fingerprint matches the stored fingerprint, the locking mechanism may be released to allow access to the wallet, purse, bag, tent, etc.

In accordance with one aspect of the present disclosure, the container case may be a wallet with a biometrically activated lock to selectively prevent opening of the wallet.

In accordance with another aspect of the present disclosure the zipper of the wallet maybe reinforced to inhibit entry by cutting the fabric of the zipper. The wallet may also be made of a slash-proof fabric and may include anti-RFID panels to prevent electromagnetic theft of card information.

In accordance with another aspect of the present disclosure the container may be a purse or handbag. The purse or handbag may be formed from slash-proof material.

In accordance with another aspect of the present disclosure the carrying case may be a backpack. The backpack may be formed so that all zippers close adjacent a common location so that a single locking mechanism can be used to retain all zippers. In the alternative, the backpack may have multiple locking mechanisms to control access to multiple pockets in the backpack.

In accordance with another aspect of the present disclosure the container may be a piece of luggage. The locking mechanism is disposed on the luggage so as to prevent opening of the luggage with the zippers unless a voice recognized command is given the locking mechanism. The locking mechanism may also have a mechanical bypass to allow transportation security agents to open the luggage if necessary prior to loading on an airplane train, etc.

In accordance with another aspect of the present disclosure the personal item container case may be a tent with the zippers configured such that the locking mechanism can hold all zippers in a closed configuration to thereby prevent access to the tent when the locking mechanism is in a locked orientation.

In accordance with another aspect of the present disclosure the locking mechanism may be disposed in communication with a wireless device. The wireless device may allow an owner of the item containing the locking mechanism to selectively deactivate the lock from a remote location. The wireless device may also allow the locking mechanism to send a wireless signal in the event the lock has been forced or otherwise tampered with. Thus, for example, if a person uses a screwdriver in an attempt to break the locking mechanism, the locking mechanism can send a signal to the user to identify the attempted access. The user then knows to investigate the situation promptly before a person is able to steal the contents of the carrying case. While a variety of different wireless protocols may be used, even a short range wireless protocol such as near field communications or Bluetooth could be used to alert the owner of the compromise bag as soon and he or she is within range. In such a manner, the owner becomes aware of the unlawful access and is able to promptly act on that information to determine if anything has been stolen, cancel credit cards, etc.

In accordance with another aspect of the present disclosure, the locking mechanism may include a power port which can be used to charge a battery which provides power to the microprocessor contained within the locking mechanism. The power port may also be structured so as to enable entry of an override code in the event that the locking mechanism malfunctions.

It will be appreciated that various embodiments of the invention may not include each aspect set forth above and aspects discussed above should not be read into the claims unless specifically described therein.

### BRIEF DESCRIPTION OF THE DRAWINGS

Various embodiments of the present disclosure are shown and described in reference to the numbered drawings wherein:

FIG. 1 illustrates a perspective view of a wallet made in accordance with principles of the present disclosure;

FIG. 2 includes a perspective view of a wallet made in accordance with one aspect of the invention;

FIG. 3 shows a close-up view of a selectively locking mechanism of the wallet shown in accordance with the principles of the present disclosure;

FIG. 4 shows a perspective view of another wallet made in accordance with principles of the present disclosure;

FIG. 5 shows a side view of the locking mechanism formed in accordance with principles of the present disclosure;

FIG. 6 shows a latch-over design for securing a pull-tab of a zipper.

FIG. 7 shows a perspective view of a purse having a biometrically activated locking mechanism disposed thereon;

FIG. 8 shows a perspective view of a backpack having a biometrically activated locking mechanism disposed thereon;

FIG. 9 shows a perspective view of a piece of luggage having a biometrically activated locking mechanism disposed thereon;

FIG. 10 shows a close-up view of a tent having a biometrically activated locking mechanism disposed thereon;

FIGS. 11 and 11A show a front view and top view of a tote having a locking mechanism disposed thereon;

FIGS. 12, 12A and 12B show a front view and to top use of a briefcase having a zipper with a locking mechanism disposed thereon;

FIGS. 13 and 13Aa show a front view and a perspective view of a computer bag with a locking mechanism disposed thereon;

FIGS. 14 and 14A show a front view and a perspective view of a handbag with a locking mechanism disposed thereon;

FIGS. 15 and 15A show a sleeping bag with a locking mechanism disposed thereon;

FIGS. 16 and 16A show a passport bag with a locking mechanism disposed thereon;

FIGS. 17 and 17A show a day planner with a locking mechanism disposed thereon;

FIG. 18 shows an alternate configuration of the locking mechanism;

FIG. 19 shows a perspective view of an alternate configuration of a zipper slider for engaging a locking mechanism;

FIG. 20 shows a side view of the zipper slider shown in FIG. 19;

FIG. 21 shows a rear perspective view of one embodiment of the zipper slider shown in FIG. 19;

FIG. 22 shows a rear perspective view of an alternate embodiment of a zipper slider shown in FIG. 19;

FIG. 23 shows a top view of the zipper slider shown in FIG. 19; and

FIGS. 24 and 25 show bottom views of the embodiments shown in FIGS. 21 and 22, respectively.

It will be appreciated that the drawings are illustrative and not limiting of the scope of the invention which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “generally” refers to something that has characteristics of a quality without being exactly that quality. For example, a structure said to be generally vertical would be at least as vertical as horizontal, i.e. would extend 45 degrees or greater from horizontal. Likewise, something said to be generally circular may be rounded like an oval but need not have a consistent diameter in every direction.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

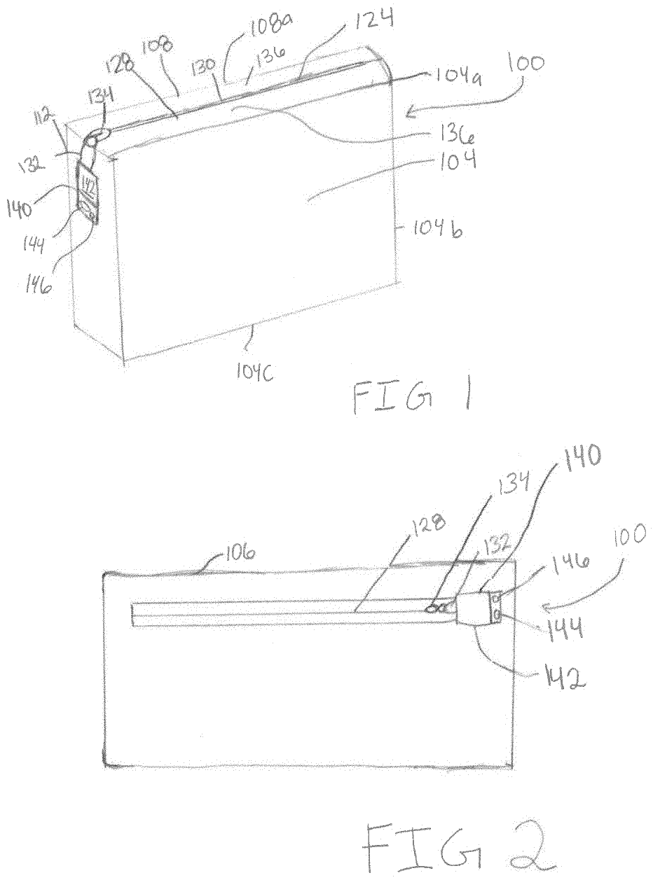

Turning now to FIG. 1, there is shown a wallet, generally indicated at 100. The wallet 100 may include a front portion 104 and a back portion 108 which may be hingedly attached to one another by a hinge portion or spine 112. The front portion 104 and the back portion 108 may include three side edges, first side edge 104A, 108A, second side edge 104B, (not shown), and third side edge 104C, (not show) which may selectively move toward and away from each other to open the wallet. The front portion 104, back portion 108, etc., may be made with material which inhibits RFID or other transmissions so as to prevent remote scanning credit cards contained in the wallet.

A closure mechanism 124 may be attached adjacent the selectively movable sides, 104A, 104B, 104C, 108A, etc. to secure the sides adjacent one another and thereby keep the wallet closed. The closure mechanism 124 may be, for example, a plurality of straps, or, as shown in FIG. 1, a zipper 128. The zipper 128 may include a plurality of teeth 130 which interlace to selectively close the zipper, and a fabric interface 136 which extends to and engages the front portion 104 and the back portion 108 along the first side sections 104A, 108A, the second side portions 104B, 108B, and the third side portions 104C, 108C. The zipper is closed by using a pull tab 132 to pull a slider 134 which interlaces the teeth 130 until the slider stops at the end of the rows of teeth.

In accordance with the present disclosure, a locking mechanism 140 may be disposed at the end of the zipper 128 so that the pull tab 132 may be inserted into the locking mechanism and held by the locking mechanism to thereby prevent opening of the zipper. The locking mechanism 140 may be spring-loaded or otherwise configured to engage and hold the pull tab 132, or maybe configured to require a voice command, such as “lock” in order to secure the pull tab and thereby lock the zipper 128 in a closed position.

With the pull tab 132 securely in the locking mechanism 140, the wallet 100 cannot be opened without either breaking the locking mechanism or cutting through the wallet. The wallet 100 may be made from a slash proof material which resists the ability for sharp objects to penetrate the fabric. Thus, if the wallet's owner finds the wallet 100 with the pull tab 132 locked in the locking mechanism, he or she knows that the contents of the wallet have not been tampered with. If, however, the pull tab 132 has been broken out of the locking mechanism 140, the user knows that the security of the wallet has been breached and that he or she should cancel any cards contained therein.

The locking mechanism may include a biometric recognition microprocessor which enables the locking mechanism to detect one or more signals based on biometric information stored in communication with a locking mechanism which can be unlocked in response to the appropriate biometric information being sensed. The biometric information could include, for example, a person's fingerprint, or a voice print. To avoid unnecessary repetition, discussion of the figures generally will be with respect to the locking mechanism which responds to a user's voice, via a microphone, etc. and a processor in communication with a voice print for verification. It will be appreciated, however, that the locking mechanisms as used herein could be other biometric readers, such as using a fingerprint scanner and a processor in communication with a stored fingerprint, or a retinal scanner and a processor in communication with a stored retinal print or an electronic record which correlates with a voice print, fingerprint or retinal scan print and the appended claims are intended to cover such unless expressly limited therein.

The locking mechanism 140 may be disposed in communication with a chip running firmware or with software which can detect authorized voices and provide signals in response thereto. As used herein, the term “voice recognition” means a microprocessor which can determine an authorized voice (and potentially an authorized phrase) and send signals in response thereto, such as by storing a biometric voiceprint and comparing subsequent detected voices to the voiceprint and determining whether they match. To access the contents of the wallet 100, the owner need only gave a vocal command, such as “open” and the locking mechanism 140 compare the voice to a story stored voiceprint and will release the tab 132 if the voices match. As will be explained below, the locking mechanism 140 includes a voice recognition (or voice biometric) microprocessor so that a person other than the owner cannot disengage the locking mechanism by giving the same vocal command. Unlike combination locks and padlocks, the locking mechanism 140 provides the owner with immediate access to the contents of their wallet, without the need for a key or memorization of a combination, or removing gloves, etc. as would be required by a fingerprint scanner. It also prevents someone from simply trying all 1000 combinations of a common three-dial combination lock which does not take long to cycle through.

The locking mechanism 140 may include a power port 144 so as to enable the insertion of power supply, such as a micro-USB plug, USB-C or other power supply to recharge a battery which powers the microprocessor (not shown in FIG. 1). Thus, if a locking mechanism 140 were to run out of power when needed by the user, he or she need merely recharge the mechanism for a few seconds to provide enough power to open the locking mechanism. This can easily be accomplished by common portable chargers which are commonly used with mobile telephones and the like.

The locking mechanism 140 may include a light 146 or other signal (e.g. auditory beep) to warn the user that the battery is getting low and should be recharged. (It will be appreciated that the battery may last a considerable amount of time because most people do not access their wallets that frequently.) The locking mechanism 140 could also have an induction coil to allow wireless recharging of an internal battery.

When the owner seeks to access the contents of his or her wallet, the user need merely say “open” or some other command the locking mechanism will release the catch (such as door 142), to release and allow access to the pull tab 132. This enables the owner to use the zipper in a normal manner.

It will be appreciated in light of the present disclosure that the locking mechanism 140 could also have a fingerprint scanner and could compare the scanned information with a fingerprint stored in the device's memory—thereby verifying if the person attempting to access the wallet, purse, etc., is authorized to do so. One advantage of using biometric data such as a fingerprint is that would allow access without noise, as a person may wish to access a wallet, purse, etc. during a meeting or other situation in which it is undesirable to speak audibly.

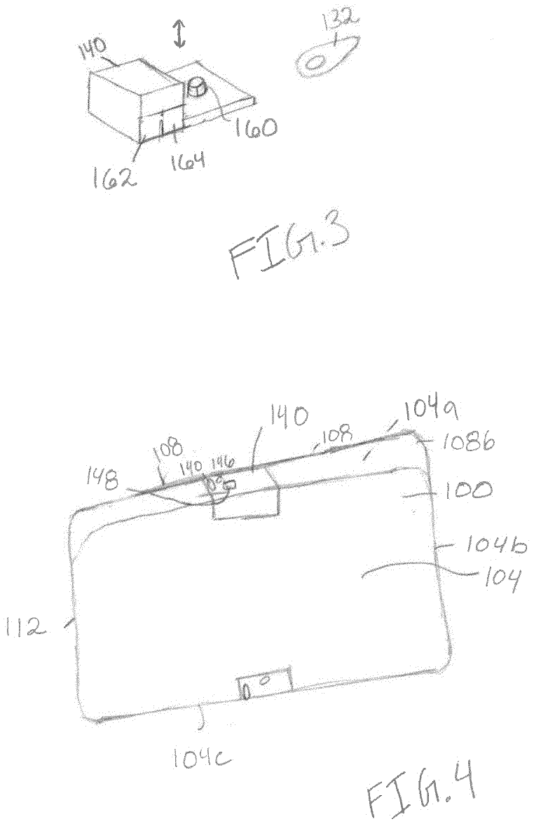

Turning now to FIG. 2, there is shown an alternate configuration of a wallet 100 which is formed by a pouch 106 with a zipper 128 extending across the top thereof in order to selectively close the pouch. The zipper 128 may be locked in place by a locking mechanism 140 which engages the pull tab 132 of the zipper to prevent the slider 134 from being drawn to the opposing end of the zipper. It will be appreciated that the locking mechanism 140 could be sized and configured to hold both the pull tab 132 and the slider 134 to prevent someone from gaining access to the wallet 100 by breaking the connection between the pull tab and the slider.

FIG. 3 shows a close-up, partially cut-away view of the selectively locking mechanism of the wallet shown in FIG. 2. The locking mechanism 140 includes a retractable engagement member 160 which may engage the pull-tab 132 to prevent the pull-tab from being pulled out of the locking mechanism. The retractable engagement member 160 may be in a biased-closed position where in the engagement member is able to deflect just enough to allow the pull-tab to pass by thereby secure the pull-tab as soon as it is inserted. Alternatively, the engagement member 160 may be actuated into both a first, open position and a second closed position. This may be accomplished by a user saying the word “lock” and a microprocessor 162 sending a signal to a motor unit 164 to move the engagement member 160 outwardly so as to engage and hold the pull tab 132 in place. As long as the engagement member 160 is disposed in the second, closed position, the engagement member is disposed in the hole 132a in the pull tab 132 and the pull tab cannot be removed from the locking mechanism 140 and thereby secures the wallet closed. To obtain access to the contents of the wallet, the owner need merely say “open” or some other command, and the engagement member 160 will move via the motor unit 164 via a command from the microprocessor 162 upon recognition of the voice command. With the engagement member 160 moved out of the way, the pull tab 132 may be pulled out of the locking member 140.

The use of voice biometrics is known and is used in computers and mobile telephones with applications such as those of VoiceVault of El Segundo, Calif., and for customer identity verification by Nuance or Burlington, Mass. A variety of voice biometrics software applications are available from Voice Biometrics Group of Newton, Pa. In light the present disclosure, it will be appreciated that a variety of chips maybe used so long as the chip is capable of being programmed with voice print and recognition commands.

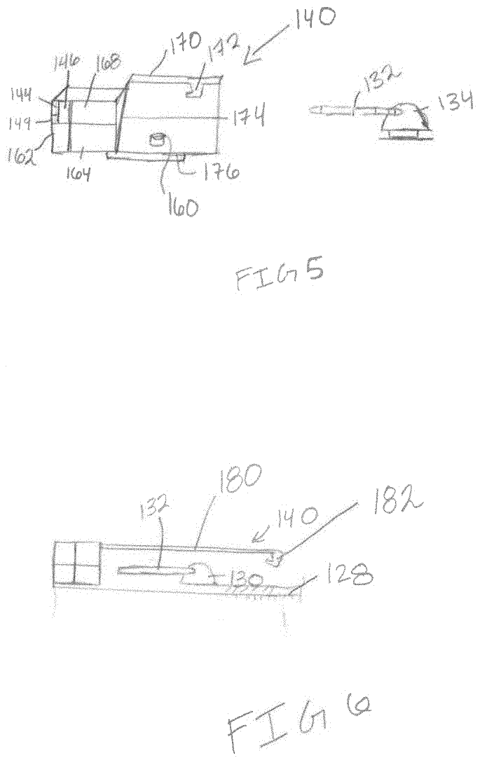

Turning now to FIG. 4, there is shown a perspective view of another wallet 100 made in accordance with principles of the present disclosure. The wallet 100 in FIG. 4 is a conventional men's bifold wallet with a front portion 104 and a rear portion 108. The edges 104a, 108a, 104b, 108b, 140c, etc. of one side move toward or away from the corresponding edges of the other side with the spine 112 acting as a hinge.

The wallet 100 includes a pair of locking mechanism 140 which engage the two sides of the wallet to prevent them from moving away from each other, thereby opening the wallet, unless then the locking mechanisms 140 have been moved into an open position to allow the two sides to separate and thereby provided access to the contents of the wallet. Thus, the owner of the wallet may simply close the wallet and say “lock” to secure the contents of the wallet 100. When the user needs to access the contents of wallet 100, he or she need merely give the instruction command and the locking mechanism 140 will release and allow the contents of the wallet to be used.

If the owner of the wallet leaves the wallet at their desk or in a public place, he or she may readily determine whether the wallet has been compromised by someone attempting to force the locking mechanisms 140. If the locking mechanism remains intact, the user knows that his confidential information has not been compromised and need not cancel his or her credit cards.

It will be appreciated, that the locking mechanism 140 may also include a wireless transmitter 148. This can be configured to send communications via Bluetooth, Wi-Fi or other wireless protocols. The signals sent from the transmitter 148 may be paired with another device, such as a mobile telephone which may provide the user with information regarding the wallet. For example, the mobile telephone could be placed on a setting which generates an alarm if a wireless signal is not perceived from the locking mechanism 140. This could provide the user with a warning when he or she is walking out of the store having left the wallet in the store. Likewise, a person getting out of their car without wallet could receive an alarm so that the wallet is not left on the car seat where it is susceptible to being stolen and encouraging a criminal to break the car window to obtain the wallet. Additionally, the locking mechanism 140 could use the transmitter 148 to communicate in attempt to force the locking mechanism. Thus, the user would know if someone had just stolen their wallet and was trying to force it open. Likewise, a person returning to their hotel room could receive a signal that someone is trying to force their wallet or other container having the locking mechanism disposed thereon. While the transmitter 148 is only shown in FIG. 4, it will be appreciated as it could be used with the structure shown in FIGS. 1 through 3 and in the remaining FIGs. discussed herein.

FIG. 5 shows a side view of the locking mechanism 140 formed in accordance with principles of the present disclosure. The locking mechanism 140 may include an engagement member 160 which receives the pull-tab 132 of the zipper. Rather than the engagement member 160 moving as discussed with respect to FIG. 3, the engagement member 160 is static. Rather, a catch door 170 having a catch 172 is hingedly mounted to a base unit 174. In use the pull-tab 132 is mounted on the engagement member 160 and the catch door 170 is closed so that the catch 172 engages an anchor structure 176. Such can be done manually without the need to utilize the microprocessor 162.

When the user/owner of the wallet or other container wishes to access the same, he or she need merely give the appropriate oral command. The microprocessor 162 detects the voice and confirms that it is the owner of the wallet, etc. The microprocessor 162 sends a signal to the motor unit 164 which moves the anchor structure 176 to release the catch 172 thereby allowing the door 170 to open so that the zipper may be removed from the locking mechanism 140 and thereby used in a conventional manner. The locking mechanism 140 may include a transmitter or transceiver 168, as well as an electronics port 144 and a perceptible indicator, such as light 146 for indicating whether a battery 149 needs to be charged.

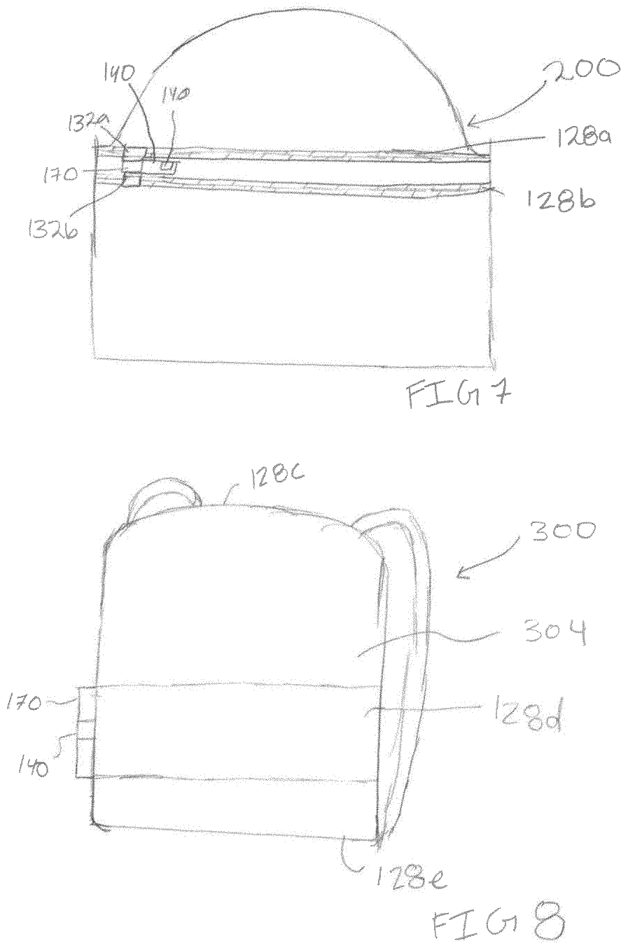

FIG. 6 shows a latch-over design of a locking mechanism 140 for securing a pull-tab of a zipper. Rather than using an engagement member 162 to engage the pull-tab 132 of the zipper 128, the door 180 is sufficiently large that the pull-tab 132 and slider 134 fit beneath the door thereby rendering them un-accessible to an unauthorized user. The door 180 may include lip 182 to prevent the pull-tab 132 and slider 134 will be removed from the locking mechanism while the door is closed. The door may function in the same manner as door 170 set forth in FIG. 5 or may be secured in some other manner.

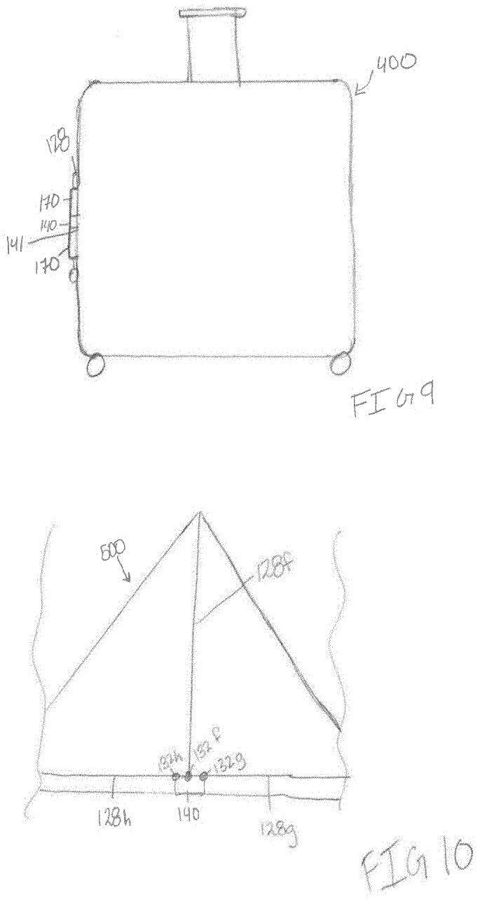

FIG. 7 shows a perspective view of a purse 200 having a voice activated locking mechanism 140 disposed thereon. It will be appreciated that purses often contain multiple zippers, such as zippers 128a and 128b. While separate locking mechanisms may be provided for each zipper, locking mechanism 140 is configured to engage both the pull-tab 132a and pull-tab 132b. This may be done, for example, by having a door 170 which covers two engagement members (not shown), each of which engages the pull tab from one of the zippers. Alternatively, both pull-tabs 132a and 132b could be mounted on a single engagement member, or the door 170 could be large enough to cover the pull-tab and slider associated with each zipper consistent with the discussion in FIG. 6. It will be appreciated that any of the different locking mechanisms discussed herein can be used with any of the wallet configurations purses or other containers.

FIG. 8 shows a perspective view of a backpack, generally indicated at 300, having a voice activated locking mechanism 140 disposed thereon. The backpack 300 includes a body 304 having multiple pockets which are closable with a first zipper 128c, a second zipper 128d and a third zipper 128e. Zipper 128c extends around the top of the backpack and alongside thereof. Zipper 128d extends across the middle portion of the backpack 300. The zipper 128e is disposed along a lower portion of the backpack. The backpack could have three distinct locking mechanisms, as shown in FIG. 8 the backpack uses a locking mechanism with one long door 170 which extends on both sides of the control of the locking mechanism. All of the zippers are configured so the pull-tabs (and possibly sliders) associated with each zipper can be secured by the door 170. This may include the use of numerous engagement members which engage the pull-tabs for the respective zippers or a door which covers the pull-tabs and sliders for each zipper. It will be appreciated that in many backpacks zippers are used with two sliders so as to enable the user to control the size of the opening along the zipper. The door 170 could be configured to hold, for example 6 different pull-tabs to ensure that a criminal cannot access the pockets of the backpack without authorization. The material of the backpack could also be made from resistant fabric to make it more difficult to access the contents thereof. The locking mechanism 140 may include any of the structures discussed above such as the microprocessor, a motor unit, a transmitter or transceiver, a port for supplying electricity, a battery, a human perceptible of signal such as a light or speaker, etc.

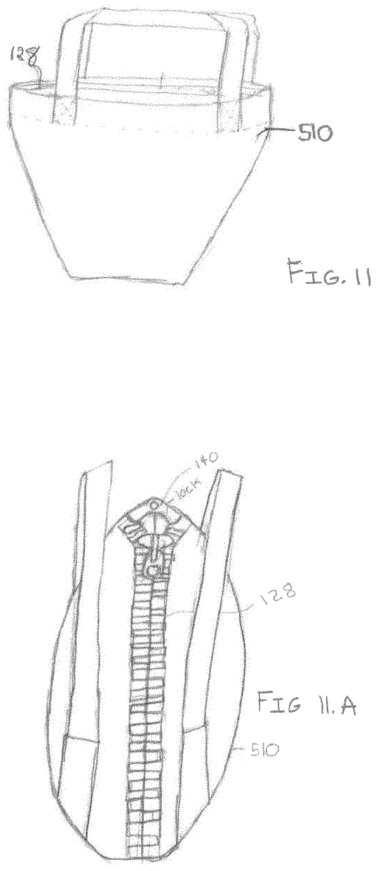

FIG. 9 shows a perspective view of a piece of luggage 400 having a voice activated locking mechanism 140 disposed thereon. The locking mechanism 140 may be placed along the zipper 128 which runs along the piece of luggage, or may be placed to the side with the pull-tabs engaging the locking mechanism. It will be appreciated that the locking mechanism can be configured in the manner of the locking mechanisms discussed above or in some similar fashion. All of the subcomponents of locking mechanism discussed above are incorporated herein for the sake of brevity and will not be discussed in detail. However, because luggage must be accessible to security personnel at airports for safety inspections and customs, the locking mechanism 140 may include a bypass lock 141 which is keyed for opening by security personnel. Those familiar with luggage design will appreciate that current combination locks on suitcases typically include a security bypass lock to allow the lock to be opened if needed by security personnel. The locking mechanism 140 may include the same structures to facilitate travel with the luggage 400.

The locking mechanism 140 may be larger than what would be used on a normal wallet and thus may more readily contain a wireless transmitter which may include Wi-Fi, Bluetooth or even cellular communications. Thus, the locking mechanism 140 may be configured to send a signal to the owner's mobile telephone in the event that the locking mechanism has sensors, such as pressure sensors, accelerometers, etc. which suggests that someone is attempting to force the lock and gain access to the luggage. Thus the owner of the luggage may be notified that someone is attempting to burglarize their room and may return from other parts of the hotel etc. to prevent the theft. Likewise, the owner may immediately seek to place a hold of her credit cards until they can verify whether they have been compromised or not.

By placing a locking mechanism 140, which is voice activated, on a piece of luggage the owner of the luggage can feel secure that no one has placed any items into or removed any items from the luggage while the owner was not watching. Additionally, the owner is provided with virtually instantaneous access to anything in the luggage which he or she may need. Rather than attempting to move the dials on a combination lock to the appropriate numbers, the owner need merely say “open” and the contents of the luggage are available. Such a locking mechanism 140 may be particularly beneficial for children, older adults, and those with neurologic issues which can make turning the small dials of a luggage combination lock difficult. It also prevents the problem of losing a key to a lock which may necessitate breaking the lock while on vacation in order to access one's clothing etc.

FIG. 10 shows a close-up view of a tent, generally indicated at 500, having a voice activated locking mechanism 140 disposed thereon. Tents are often provided with multiple zippers, such as zippers 128f, 128g and 128h. The zippers allow the tent door to be opened wide to allow in fresh air or a view of scenery while one is in the tent. One concern of leaving anything of value in a tent is that most tents provide no security. When the owner of the tent is fishing, hiking, or engaging in other activities, anyone can access the tent. Many people are concerned with valuables which may be left in the tent including mobile telephones, tablets, personal videogame devices, etc. Thus, people often attempt to hide such items within sleeping bags or under clothing etc. in the tent. Another concern, however, may be a person's food which could be tampered with while a person is out and is difficult to ascertain upon return.

The locking mechanism 140 shown in FIG. 10 may be configured to receive the pull-tabs 132f, 132g, 132h associated with the zippers 128f, 128g and 128h. By locking the zippers in a closed configuration a person cannot gain access to the tent without it being apparent that the tent has been broken into. If such happens, the owner can immediately take appropriate action to determine whether items have been stolen or potentially tampered with. Depending on the configuration of the locking mechanism, breaking open the locking mechanism to allow access may require considerable force and tools which are not normally available at a campsite without actually cutting the tent material. Additionally, the locking mechanism may keep out animals, such as squirrels, rats, raccoons and the like which have sufficient dexterity to move an unsecured pull-tab/slider on a zipper.

While discussed herein as including a voice activated feature which recognizes the owner's voice, it will be appreciated that the locking mechanism may also include other biometrics sensors such as a fingerprint scanner etc. if desired. Likewise, a variety of other security mechanisms can be used such as hardened materials, slash-proof materials, etc.

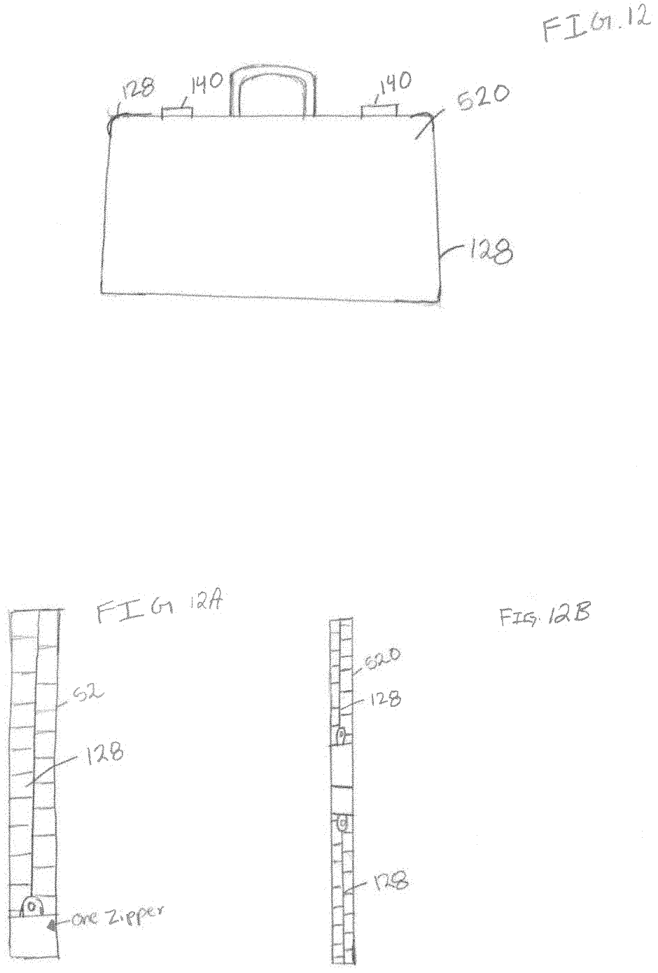

Turning now to FIGS. 11 and 11A there is shown a tote 510. The tote 510 includes a zipper 128i and a locking ring mechanism 140 which can function in a manner similar to that discussed above to lock the tote and thereby deter pickpockets and thieves.

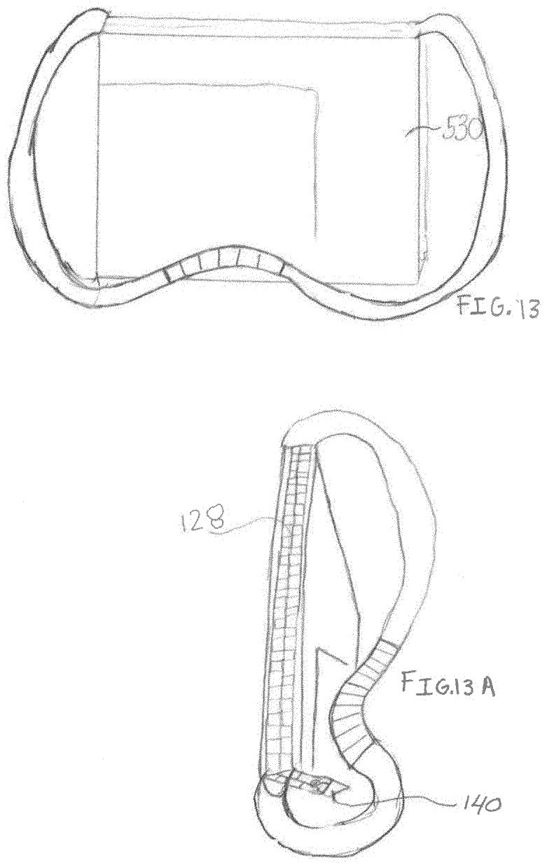

FIGS. 12, 12A and 12B show a briefcase 520. The briefcase 520 may include a zipper 128j, or a pair of the zippers 128j as shown in FIG. 12B. The locking mechanism 140 can be used to secure the briefcase in a closed position.

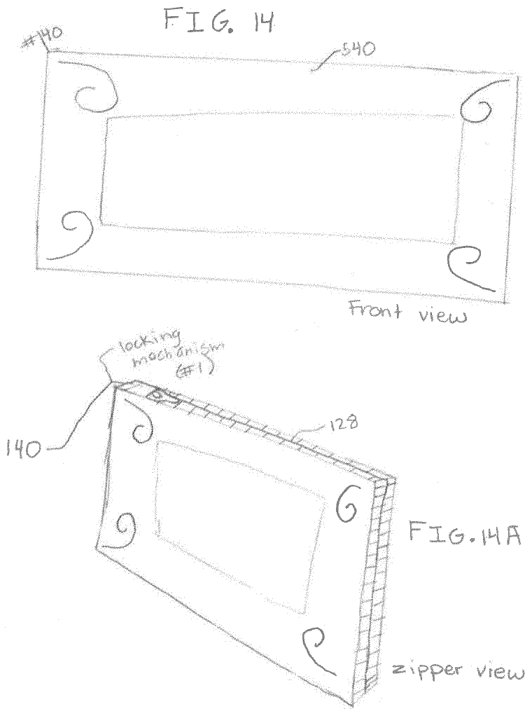

FIGS. 13 and 13A show a computer bag 530 which includes a zipper 128 and a locking mechanism 140 which can selectively lock the zipper as described above. It will be understood that such a computer bag as advantageous as it would prevent someone from accessing a person's computer to install malware or the like and then replacing it in the person's computer bag without detection.

FIGS. 14 and 14A show a handbag 540 with a zipper 128 and a locking mechanism 140. The locking mechanism prevents access to the handbag, but allows ready access when the user speaks and the voice biometric software or other programming on the microprocessor recognizes the user's voice and releases the zipper to provide access.

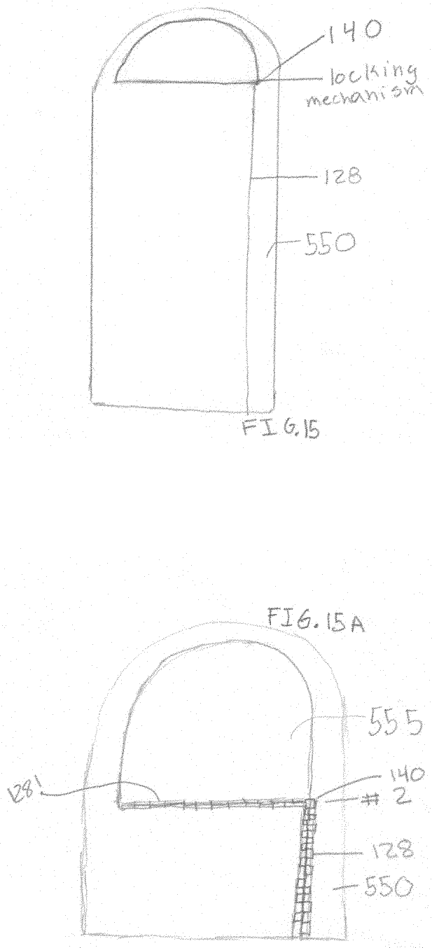

FIGS. 15 and 15A show a front view and a close-up view of a sleeping bag 550 having a zipper 128 and a locking mechanism 140. While sleeping bags are not usually used to contain contents, it is not uncommon for campers to hide items in their sleeping bags so they do not get stolen while on hikes, etc. The sleeping bag may include a flap 555 which can be closed via a second zipper 128i which engages the locking mechanism 140 so that when the zippers 128, 128a is closed the contents of the bag cannot be accessed. Such a sleeping bag 550 would be desirable where it is unlikely that other campers would steal the entire bag, but might remove money or cards from someone's wallet. Parents could also use the bag to hold alcohol or other contents so that they are unavailable to children when the parents are not around.

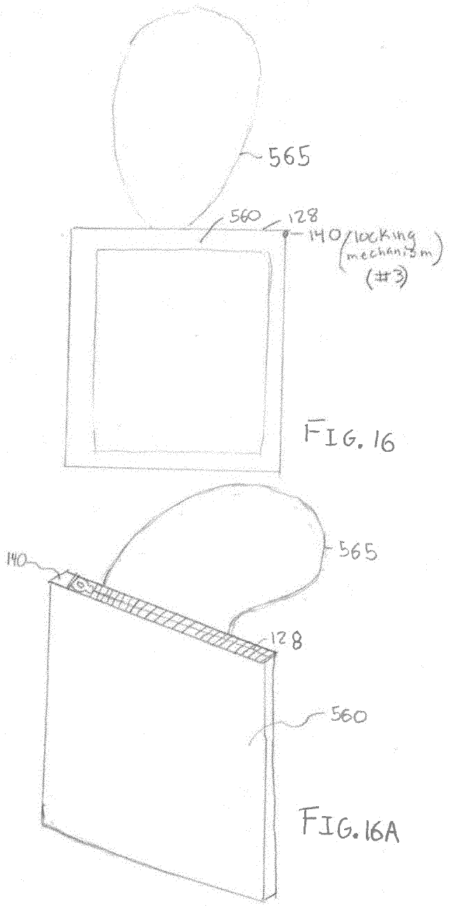

FIGS. 16 and 16A show a passport bag 560 having a cord 565 a zipper 128 and a locking mechanism 140. Passport bags are typically worn around the user's neck in an attempt to reduce the risk that a pickpocket will steal a passport. However, the passport bag can still be accessed by a particularly good pickpocket. With the zipper 128 and locking mechanism 140, it would be extremely difficult for a pickpocket to access the contents of the passport bag 560.

FIGS. 17 and 17A show a day planner 570 which includes a zipper 128 and locking mechanism 140 as with the previous embodiments, the locking mechanism helps the user prevent access to the contents so as to ensure the integrity thereof.

FIG. 18 shows an alternate configuration of the locking mechanism 140. The locking locking mechanism 140 may include a microprocessor 162 which interacts with an engagement unit 160. The engagement unit 160 includes a solenoid 580 which is biased into a closed position by a spring 584 and electrical unit 586 which actuates in response to a signal from the microprocessor 162 to move the solenoid from the closed position to an open position to thereby release the pull-tab of the zipper (not shown). Because the solenoid 580 is biased in a closed position, it uses no electricity until actuated to release the pull-tab. It will be appreciated that the locking mechanism may also include an on-off button 590 to allow the owner to turn off the locking mechanism 140 in a locked position to reduce power consumption and then press or otherwise activate the on-off button 590 to turn the microprocessor on and allow a biometric voice match to unlock the locking mechanism.

Again, it will be appreciated that while the above examples are discussed in conjunction with a biometric voice match, another biometric information base could be provided, such as fingerprints. On particularly valuable devices, the locking mechanism could be disposed in communication with a retinal scanner.

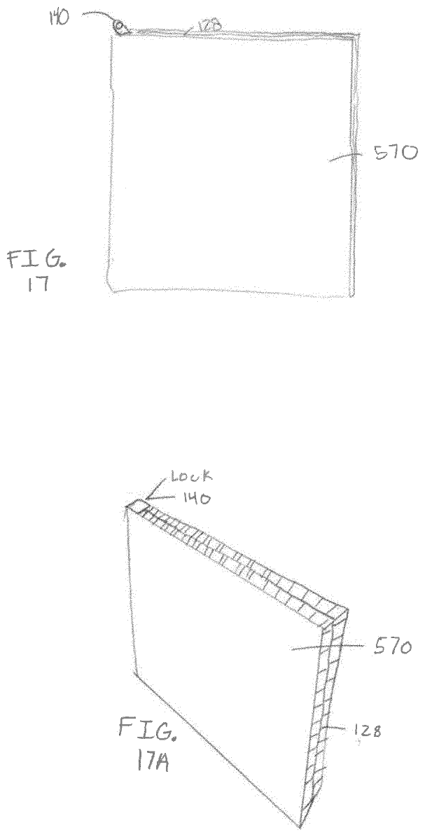

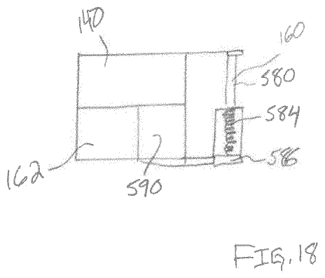

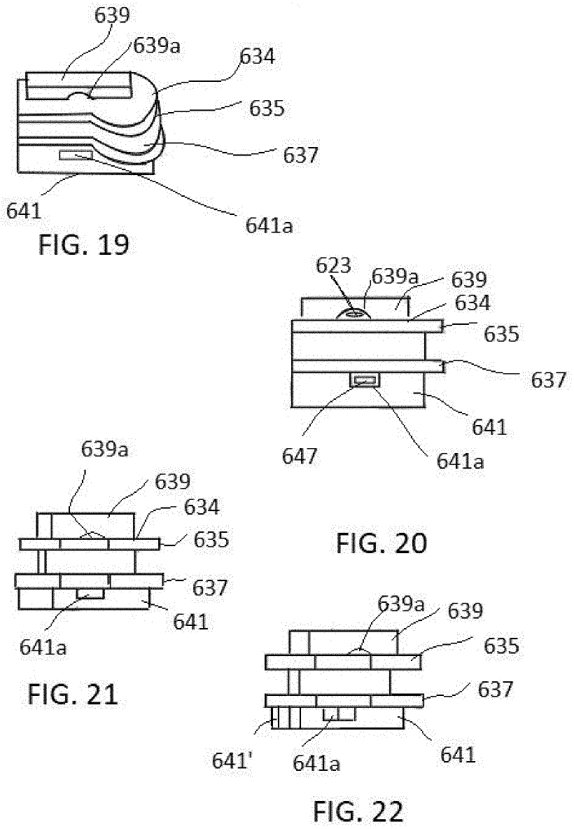

Turning now to FIG. 19, there is shown a zipper slider 634 made in accordance with one aspect of the disclosure. The zipper slider 634 may include an upper face 635 and a lower face 637 which may be disposed on opposing sides of the teeth of a zipper to assist in tracking the teeth into interconnected engagement and disengagement. Disposed above the upper face 635 may be a zipper pull-tab mount 639 which may include a hole or void 639a for receiving a pull-tab. The zipper slider 634 may also include a locking member receiver 641 disposed below the lower face 637. The locking member receiver 641 may include a hole or other void for receiving a portion of a locking member, such as a bolt, solenoid or other structure of an engagement member.

Those familiar with zippers will realize that the pull tab can be a point of attack. A person attempting to break into a piece of luggage, etc., may use a screw driver leveraged under the pull tab in an effort to obtain access by breaking the pull tab. In the embodiment shown in FIG. 18, the pull tap (not shown) could be completely broken off the zipper slider 634 and yet the zipper slider would be held in place by the locking member extending into the locking member receiver 641.

Turning to FIG. 20, there is shown a side view of the zipper slider 634 so that the upper face 635 and lower face 637 are visible. The zipper pull-tab mount 639 may be disposed above the upper face to receive a portion of the pull-tab 623. The locking member receiver 641 may be disposed below the lower face 637 and be designed to receive a portion 647 of a locking member such as a bolt, catch, solenoid, etc. to catch and hold the zipper slider 634 in a desired location. Even if the pull-tab 623 is removed, the locking member (not shown) can hold the zipper slider 634 in place.

Turning now to FIGS. 21 and 22, there are shown rear perspective views of two embodiments of the zipper sliders 634 and 634′. The zipper slider 634′ in FIG. 21 is similar to the zipper slide 634 shown in FIG. 20, except that the locking member receiver is formed from two portions 641 and 641′ each of which may have a hole or void for receiving a portion of the locking member. The space between the two locking member receiver portions 641 and 641′ can be used to receive a tracking rail or some other structure to provide additional strength to the zipper slider 634′ when it is in the locked position. One or two solenoids, catches or other structures of the locking members can engage the holes in the receiver portions to lock the zipper slide in place.

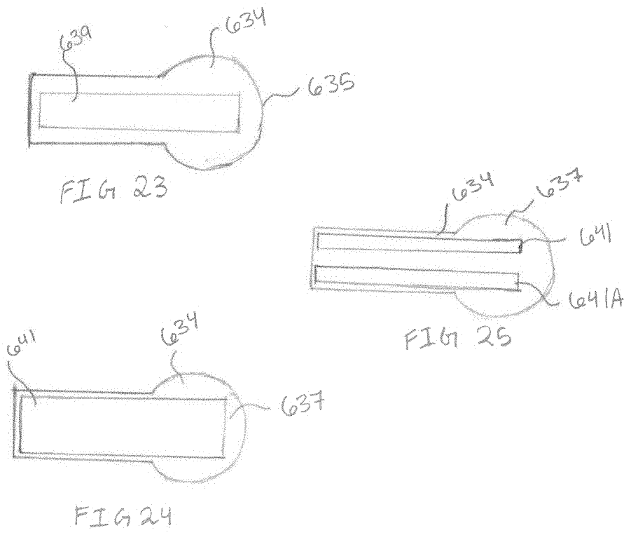

FIG. 23 show a top view of the zipper slider 634 (which would look the same for the zipper slider 634′). FIGS. 24 and 25 show bottom views for the zipper sliders 634 and 634′ respectively.

Thus there is disclosed multiple embodiments of a locking enclosure for personal belongings including a container and a voice activated locking mechanism for selectively preventing access to the contents of the container. It will be appreciated that numerous modifications may be made without departing from the scope and spirit of this disclosure. The appended claims are intended to cover such modifications.

What is claimed is:

1. A container having a biometric activated locking mechanism attached thereto, the biometric activated locking mechanism having a first open position and a second, locking position and wherein the biometric activated locking mechanism prevents the container from being opened when in the second, locking position.

2. The container of claim 1, wherein the biometric activated locking mechanism includes voice recognition software.

3. The container of claim 1, wherein the biometric activated locking mechanism includes a fingerprint scanner.

4. The container of claim 1, wherein the container is a wallet.

5. The container of claim 1, where in the container is a purse.

6. The container of claim 1, wherein the container is a backpack.

7. The container of claim 1, wherein the container is a tent.

8. The container of claim 1, wherein the container is a suitcase.

9. The container of claim 1, wherein the container has a zipper having a pull-tab, and wherein the voice activated locking mechanism selectively engages the pull-tab to limit movement of the pull-tab.

10. The container of claim 1, wherein the voice activated locking mechanism includes a light.

11. The container of claim 1, wherein the voice activated locking mechanism includes a charging port.

12. The container of claim 1, wherein the voice activated locking mechanism includes a catch door.

13. The container of claim 1, wherein the voice activated locking mechanism includes an engagement member configured for insertion into a pull-tab of a zipper.

14. The container of claim 1, wherein the engagement member is disposed in communication with a motor unit so as to selectively move the engagement member.

15. The container of claim 1, wherein the voice activated locking mechanism includes a transmitter.

16. The container of claim 13, wherein the voice activated locking mechanism is programmed to transmit a signal upon determination that someone has attempted to force open the locking mechanism.

17. The container of claim 1, wherein the microprocessor has a voiceprint store thereon and wherein the microprocessor is programmed to compare a voice to the voiceprint and unlock the locking mechanism in response to a voice which matches the voiceprint.

18. The container of claim 1, wherein the container includes a zipper and a zipper slider and wherein the zipper slider has a locking member receiver formed thereon for engaging the locking mechanism.

19. The container of claim 18, wherein the locking member receiver has a hole formed therein.

20. The container of claim 18, wherein the locking member receiver has a first portion having a hole or void formed therein for receiving a part of the locking mechanism and a second portion, spaced apart from the first portion, the second portion having a hole or void formed therein for receiving a part of the locking mechanism.
